(19) United States
(12) Patent Application Publication
(10) Pub. No.: US 2018/0060747 A1
(43) Pub. Date: Mar. 1, 2018

(54) INTELLIGENT CANDIDATE GENERATION FOR LARGE-SCALE LINK RECOMMENDATION

(71) Applicant: Linkedln Corporation, Mountain View, CA (US)

(72) Inventors: Souvik Ghosh, San Jose, CA (US); Wei Lu, San Jose, CA (US); Myunghwan Kim, San Jose, CA (US); Hema Raghavan, Mountain View, CA (US)

(21) Appl. No.: 15/298,001

(22) Filed: Oct. 19, 2016

Related U.S. Application Data
(60) Provisional application No. 62/378,586, filed on Aug. 23, 2016.
(60) Provisional application No. 62/404,871, filed on Oct. 6, 2016.

(51) Int. Cl. G06N 5/04; H04L 29/08

(52) U.S. Cl. CPC G06N 5/046; H04L 67/306

(57) ABSTRACT

A system, a machine-readable storage medium storing instructions, and a computer-implemented method are described herein are directed to a Candidate Engine. The Candidate Engine generates a key(s) based on respective shared attributes between first profile data of a first member account and second profile data of a second member account in a social network service, The Candidate Engine assembles, according to encoded rules of a prediction model, feature vector data for each key. The encoded rules comprises at least one pre-defined feature predictive of an affinity between the first member account and the second member account. The Candidate Engine processes, according to the prediction model, the feature vector data for each key. The Candidate Engine receives predictive output from the prediction model.

### CROSS-REFERENCE TO RELATED APPLICATIONS

This application claims the benefit of priority to U.S. Provisional Patent Application entitled “Triangle Closing Over The Economic Graph,” Ser. No. 62/378,586, filed Aug. 23, 2016, which is hereby incorporated herein by reference in its entirety.

This application claims the benefit of priority to U.S. Provisional Patent Application entitled “Intelligent Candidate Generation r Large-Scale Link Recommendation,” Ser. No. 62/404,871, filed Oct. 6, 2016, which is hereby incorporated herein by reference in its entirety.

### TECHNICAL FIELD

The subject matter disclosed herein generally relates to the technical field of special-purpose machines that facilitate identification of relationships between one or more member accounts in a social networking service, including software-configured computerized variants of such special-purpose machines and improvements to such variants, and to the technologies by which such special-purpose machines become improved compared to other special-purpose machines that facilitate identification of relationships between one or more member accounts in a social networking service.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Candidate Engine, according to some embodiments;

FIG. 4 is a block diagram of a key data hierarchy, in accordance with an example embodiment;

FIG. 5 is a block diagram of profile data attributes of member accounts, in accordance with an example embodiment;

FIG. 6 is a block diagram showing a plurality of keys as input into a prediction model, in accordance with an example embodiment;

FIG. 7 is a flowchart illustrating an example method for calculating an affinity score according to a prediction model, according to an example embodiment;

FIG. 8 is a block diagram of an example computer system on which methodologies described herein may be executed, in accordance with an example embodiment.

### DETAILED DESCRIPTION

The present disclosure describes methods and systems for predicting whether social network connection requests will be selected by one or more social network account in a professional social networking service (also referred to herein as a “professional social network” or “social network”). In the following description, for purposes of explanation, numerous specific details are set forth in order to provide a thorough understanding of the various aspects of different embodiments described herein.

A system, a machine-readable storage medium storing instructions, and a computer-implemented method are described herein are directed to a. Candidate Engine. The Candidate Engine determines an affinity between member accounts in a social network service that have yet to establish a social network connection between each other. An affinity is a determination of how likely the actual users (i.e. the persons) represented by the member accounts may know each other in the physical world. In some embodiments, the Candidate Engine identifies shared attributes in the profile data of two member accounts describing educational institutions, employers and location to generate keys. By generating the keys based the shared profile attributes, the Candidate Engine generates input for a prediction model that represents that the users represented by the member accounts may have attended schools or worked at the same locations—thereby implying that there may an increased probability that they know each other. The keys are utilized as input for one or more features for an encoded logistic regression model. The encoded logistic regression model assembles one or more feature vectors based on the profile data in the input keys. The Candidate Engine calculates an affinity score based on the feature vectors. If the affinity score meets a score threshold, the Candidate Engine sends notifications to the member accounts to prompt the member accounts to establish a social network connection. The Candidate Engine thereby increases a probability that the member accounts will choose to establish the social network connection since a determination has already been made that the users represented by the member accounts most likely know each other.

According to various exemplary embodiments, the Candidate Engine generates a key(s) based on respective shared attributes between first profile data of a first member account and second profile data of a second member account in a social network service. The Candidate Engine assembles, according to encoded rules of a prediction model, feature vector data for each key. The encoded rules comprise at least one pre-defined feature predictive of an affinity between the first member account the second member account. The Candidate Engine processes, according to the prediction model, the feature vector data for each key. The Candidate Engine receives predictive output from the prediction mix model. The predictive output is indicative of the affinity between the first member account and the second member account,

Conventional social networking systems typically provide link recommendations—such as a conventional version of a recommender system—to help social network accounts expand their connected social networks. Such systems often employ machine learning (ML) techniques to learn a model that predicts the probability of a given pair of social network accounts taking an action to establish a social network connection link with between their social network accounts, and then recommend top-K results from the model for each social network account. Due to the quadratic nature of the link recommendation problem, scalability is a big challenge, especially for large networks. Specifically, it is infeasible for the model to calculate a recommendation score for all possible pairs of many members(i.e. social network accounts) on a professional social network system.

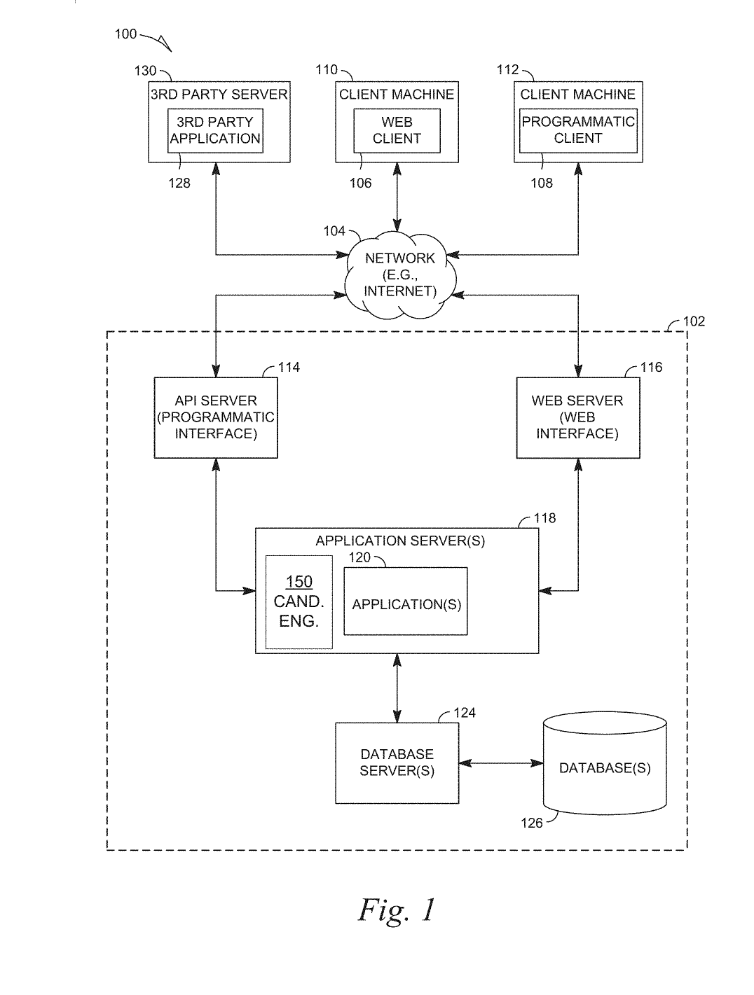

In contrast to conventional systems, a system, a machine-readable storage medium storing instructions, and a computer-implemented method as described herein are directed to a Candidate Engine 150 (as illustrated in FIG. 1). According to various exemplary embodiments, the Candidate Engine 150 described herein determines, for one or more social network accounts, a pre-selected candidate set of node pairs to score. It is understood that the Candidate Engine 150 includes one or more hardware-implemented modules that controls, manages and stores information related to executing one or more of the actions and operations described herein. The Candidate Engine 150 also includes one or more hardware-implemented modules that controls, manages and stores information related to generating, storing, transmitting and causing display of any data, information, result and score described herein. In example embodiments, the Candidate Engine 150 executes one or more method steps based on actions, operations, data, information, results and scores described herein. In example embodiments, the Candidate Engine 150 includes one or more machine-readable storage medium storing instructions for executing any of the actions, operations described herein and for generating, storing, transmitting and causing display any of the data, information, results and scores described herein.

A candidate set of member accounts can be defined by the Candidate Engine 150 according to one or more heuristic rules, which presents a challenging trade-off between scalability and liquidity. A candidate set can be defined for one specific social network account, a specific pairing of social network accounts, or for any number of social network account. On the one hand, if the candidate set is defined as including up to a second-degree network of one or more social network accounts, then lower-degree social network connections (either new or inactive) suffer from low liquidity, which would slow down the growth of their respective social networks. Note that most social network accounts have low degrees according to the power-law degree distribution, and thus encouraging new/inactive social network accounts to form more links through sufficiently many recommendations is crucial for growing the overall number of engaged social network accounts. On the other hand, if a candidate set is defined as including up to a third-degree network of one or more social network accounts, then too many candidate accounts will be generated for high-degree (i.e. highly-active, highly-engaged) social network accounts, which may negatively affect scalability. Hence, the Candidate Engine 150 provides a balance between high scalability and high liquidity when choosing one or more candidate sets for a recommender system in the professional social network system.

In exemplary embodiments, the Candidate Engine 150 implements a “Personalized PageRank (PPR) over the Economic Graph (EG) model that is represented according to one or more computer instructions. Personalized PageRank (PPR) is a well-known algorithm to compute the topological proximity from a source node to a target node—or proximity between a pair of social network accounts since each node can represent a specific social network account. The Economic Graph (EG) is a heterogeneous network over a plurality of social network accounts (i.e. users, members, member accounts) and their profile entities, or profile data (e.g. schools, companies, locations, education data, employment data, groups, discussions, skills etc.) in the professional social network system. Through PPR, any number of candidates are identified from the social graph based on a proximity score. By accessing the Economic Graph, the quality of each candidate set can be further enhanced by factoring in proximity according to one or more portions of profile data. The actions and operations of the Candidate Engine 150 are fully distributed and personalized, independent of applications (i.e. not restricted to solely for implementation with a recommender system), and allows for easy control over the above-described scalability/liquidity trade-off through one or more (or few) parameters.

PPR has been shown useful for various network mining problems such as Supervised Random Walk (SRW), community detection, a recommendation system that identifies a user that should be followed by another user. According to SRW, a ML model is used to determine the link weights for the random walk, while the Candidate Engine 150 implements PPR to determine one or more candidate pairs to which the ML model applies.

The Candidate Engine 150 has several advantages over SRW. First, PPR implemented according to the Candidate Engine 150 is not dependent on a specific type of an ML model. Once a threshold number of candidates in a candidate set has been generated that meets one or more quality criterion, any type of ML model can be then be used in the Candidate Engine 150 for recommending links (i.e. social network connections) between social network accounts. Second, the Candidate Engine 150 detects one or more instances of dynamic change that occurs in the graph. Note that dynamic changes occurs when one or more nodes and one or more edges are created and/or deleted, and thus the network of each social network account can gradually change even if the social network account does not form additional social network connections, As such, incremental updates based on detected dynamic change is critical as re-running algorithm by the Candidate Engine 150 for full a graph requires a lot of resources.

In various embodiments, for PPR, if the Candidate Engine 150 captures one or more random-walk samples and updates one step every day (or any period of time), and sets a teleport probability variable as 0.25 (or any value), then the average age of the network used for the random-walk is 4 days. Third, the trade-off between accuracy and scalability can be controlled by just a desired number of parameters (or a few parameters). The Candidate Engine 150 implements Markov Chain Monte Carlo (MCMC) sampling, where only two parameters are needed, which are a first parameter indicating the number of iterations and a second parameter indicating the number of samples per iteration. Increasing the number of samples improves accuracy but hurts scalability. Similarly, an increase in the number of iterations helps the scalability of the algorithm executed by the Candidate Engine 150, but violates the independence among the samples.

Conventional recommender systems that identify candidates utilize economic graph (“EG”) only according to a conventional and limited extent by: (i) “triangle closing” over a social graph (such as a subgraph of EG—which simply generates second-degree neighbours). In contrast, the Candidate Engine 150 computes pairwise affinity based on a time overlap that two social network accounts have in an organization (such, for an example, as a common employer organization or school). As such, conducting PPR over the EG according to the Candidate Engine 150 is a more principled and unified way to utilize both graph and profile data to the fullest extent.

In example embodiments, the Candidate Engine 150 conducts “triangle closing” over EG, in which the scope of random walks in PPR is restricted to pairwise member nodes that share at least one common member connection. The Candidate Engine 150 materializes the EG by adding one or more profile entity nodes (that respectively correspond to a particular member account) and one or more location nodes to the social graph. For example, a pair of member accounts (u, v) are eligible as candidates in a candidate set if u and v are both connected to at least one combination of a profile entity node w (e.g., received education in Stanford University) and one location node l (e.g., San Francisco Bay Area). The overlap of (u, v) with respect to (w, l) contributes a new pair feature type of the ML model of the Candidate Engine 150, and thus increases the predicted connection probability between u and v. To balance between scalability and liquidity, the Candidate Engine 150 applies a parameter r. For example, in each run of this job (e.g., once per day, for example), for each member u and each (w, l) connected to u in the EG, the Candidate Engine 150 samples r candidates uniformly at random.

In various embodiments, the prediction model of the Candidate Engine 150 is built, trained and implemented according to one of various known prediction modeling techniques. Training data is used to train the prediction model. The training process identifies the types of pre-defined features of the prediction model and determines and continually updates) the values of each regression coefficient assigned to each type of pre-defined feature.

To build and train each service model and the freelancer inference model, the Candidate Engine 150 may perform a prediction modeling process based on a statistics-based machine learning model such as a logistic regression model. Other prediction modeling techniques may include other machine learning models such as a Naive Bayes model, a support vector machines (SVM) model, a decision trees model, and a neural network model, all of which are understood by those skilled in the art.

According to various exemplary embodiments, the Candidate Engine 150 may be executed for the purposes of both off-line training (for generating, training, and refining the prediction model) and online identifications of types of services and specialties and freelancer classifications. According to various exemplary embodiments, the Candidate Engine 150 may be used for the purposes of both off-line training of one or more logistic regression models as well as online determinations and calculations of an affinity between member accounts that have not yet established a social network connection.

As described in various embodiments, the Candidate Engine 150 may be a configuration-driven system for building, training, and deploying models for calculating affinity between member accounts. In particular, the operation of the Candidate Engine 150 is completely configurable and customizable by a user through a user-supplied configuration file such as a JavaScript Object Notation (JSON), eXtensible Markup Language (XML) file, etc.

For example, each module in the Candidate Engine 150 may have text associated with it in a configuration tile(s) that describes how the module is configured, the inputs to the module, the operations to be performed by the module on the inputs, the outputs from the module, and so on. Accordingly, the user may rearrange the way these modules are connected together as well as the encoded rules that the various modules use to perform various operations. Thus, whereas conventional prediction modeling is often performed in a fairly ad hoc and code driven manner, the modules of the Candidate Engine 150 may be configured in a modular and reusable fashion, to enable more efficient identification and classification.

It is understood that various embodiments further include encoded instructions that comprise operations to generate a user interface(s) and various user interface elements. The user interface and the various user interface elements can be displayed to be representative of any of the operations, data, models, keys, profile data, affinity, pre-defined features, member accounts and invitations, as described herein. In addition, the user interface and various user interface elements are generated by the Candidate Engine 150 for display on a computing device, a server computing device, a mobile computing device, etc.

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

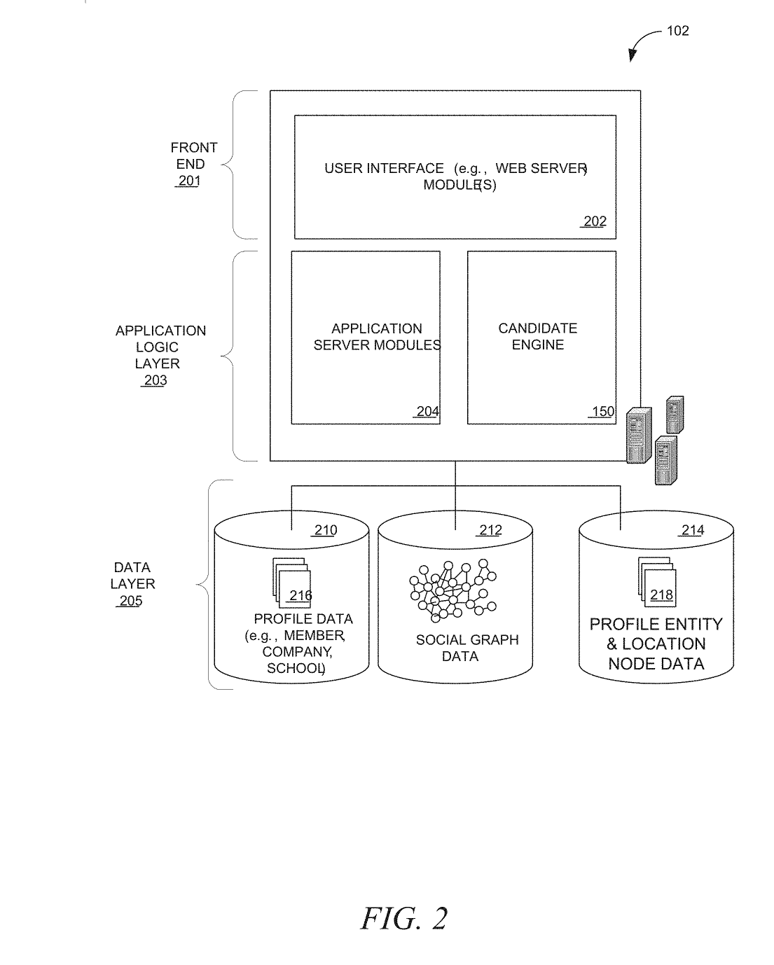

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface modules) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted. to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization account with the professional social network the representative may be prompted to provide certain information about the organization. This information may he stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212, The data layer 205 also includes a. profile entity and location nodes database 214 which includes data 218 for one or more instances of profile data overlap between social network accounts (such as member accounts) with respect to a respective profile entity node and a respective location node that contribute to the new pair feature type of the prediction model. Stated differently, the data 218 is utilized to generate keys form the prediction model.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

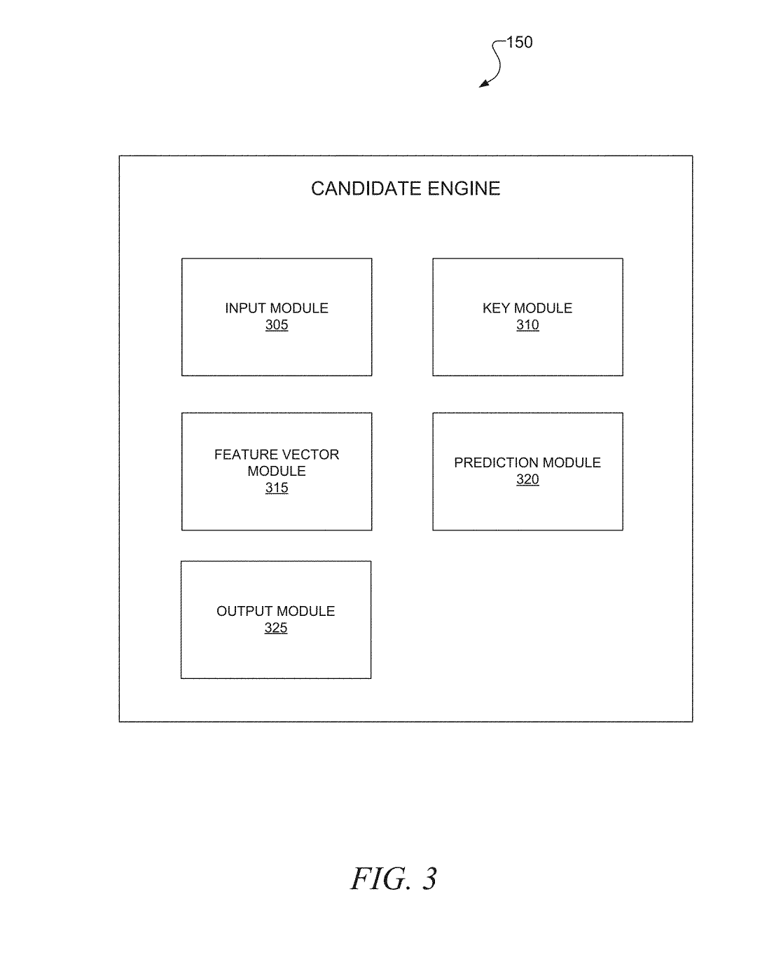

The data in the data layer 205 may be accessed, used, and adjusted by the Candidate Engine 150 as will be described in more detail below in conjunction with FIG. 3. Although the Candidate Engine 150 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 3 is a block diagram showing example components of a Candidate Engine 150, according to some embodiments. As shown in FIG. 3, the Candidate Engine 150 includes an input module 305, key module 310, feature vector module 315, prediction module 320 and an output module 325. While the modules 305, 310, 315, 320 and 325 are described as performing specific operations, one of ordinary skill in the art will appreciate that such modules may be configured to perform alternative and/or additional operations.

The input module 305 is a hardware-implemented module that controls, manages and stores information related to any inputs from one or more components of system 102 as illustrated in FIG. 1 and FIG. 2. In various embodiments, inputs can include profile data from one or more member account and one or more attribute hierarchies.

The key module 310 is a hardware-implemented module which manages, controls, stores, and accesses information related to generating one or more keys to be utilized as input into a prediction model of the Candidate Engine 150.

The feature vector module 315 is a hardware-implemented module which manages, controls, stores, and accesses information related to assembling a feature vector for a target member account. The vector module 320 assembles, according to encoded rules of the prediction model, feature vector data based on one or more input keys.

The prediction module 320 is a hardware-implemented module which manages, controls, stores, and accesses information related to building, training and updating a prediction model. For example, the prediction modelling module 325 updates the pre-defined features and coefficients represented by one or more encoded instructions of a prediction model.

The output module 325 is a hardware-implemented module which manages, controls, stores, and accesses information related to calculating a predictive output score. The predictive output score is an affinity score which represents a likelihood of whether users represented by member accounts know each other in the physical world.

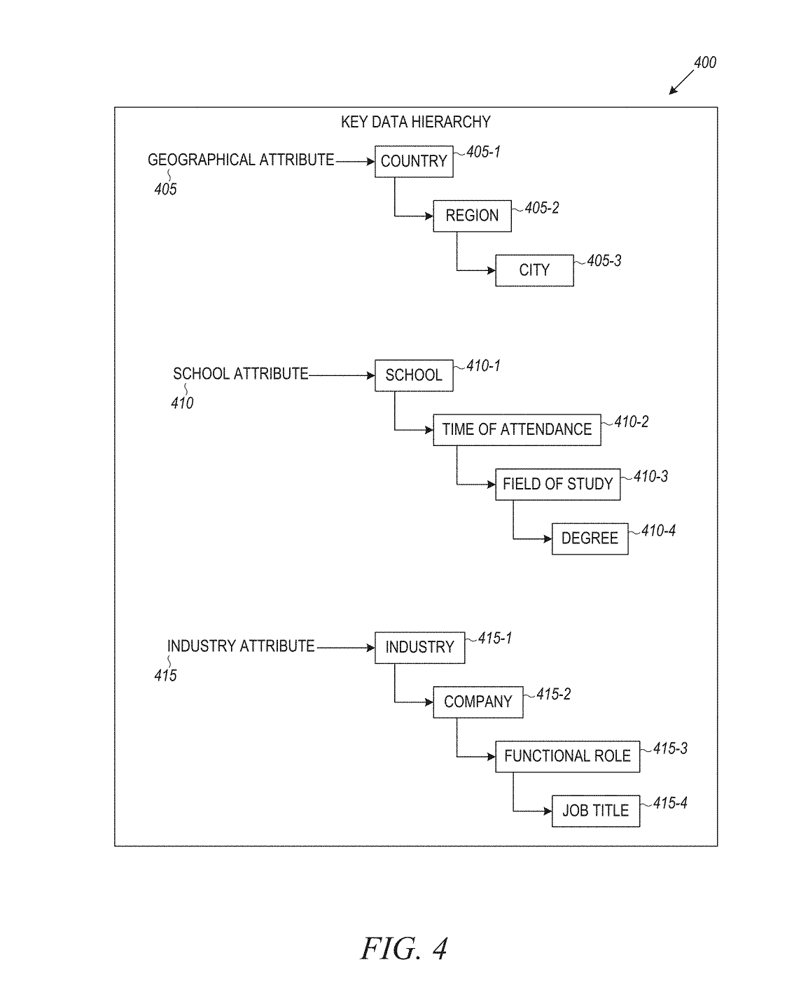

FIG. 4 is a block diagram of a key data hierarchy, in accordance with an example embodiment.

The Candidate Engine 150 generates keys that map to pre-defined types of features of the prediction model. Each key is based on profile attributes that are present in profile data of a first member account and a second member account. The Candidate Engine 150 includes a predefined key data hierarchy 400 for various types of attribute hierarchies 405, 410, 415. Each level in an attribute hierarchy 405, 410, 415 is assigned to a coefficient of the prediction model since a shared attribute in a particular level of an attribute hierarchy 405, 410, 415 may be indicative that a user of the first member account and a user of the second member account know each other in the physical world.

The key data hierarchy 400 includes a pre-defined geographic attribute hierarchy 405. The geographic attribute hierarchy 405 includes a first level for a country descriptor 405-1, a second level for a region descriptor 405-2 and a third level for a city descriptor 405-3. A coefficient is assigned to each level of the geographic attribute hierarchy 405. The coefficient for the region descriptor 405-2 is more predictive of affinity than the coefficient for the country descriptor 405-1. The coefficient for the city descriptor 405-3 is more predictive of affinity than the coefficient for the region descriptor 405-2.

The key data hierarchy 400 includes a pre-defined school attribute hierarchy 410. The school attribute hierarchy 410 includes a first level for a school descriptor 410-1, a second level for a time of attendance descriptor 410-2, a third level for a field of study descriptor 410-3 and a fourth level for academic degree obtained descriptor 410-4. A coefficient is assigned to each level of the school attribute hierarchy 410. The coefficient for the time of attendance descriptor 410-2 is more predictive of affinity than the coefficient for the school descriptor 410-1. The coefficient for the field of study descriptor 410-3 is more predictive of affinity than the coefficient for the time of attendance descriptor 410-2. The coefficient for the degree obtained descriptor 410-4 is more predictive of affinity than the coefficient for the field of study descriptor 410-3.

The key data hierarchy 400 includes a pre-defined industry attribute hierarchy 415. The industry attribute hierarchy 415 includes a first level for an industry descriptor 415-1, a second level for a company name descriptor 415-2, a third level for a job functional role descriptor 415-2 and a fourth level for a job title descriptor 415-4. A coefficient is assigned to each level of the industry attribute hierarchy 410. The coefficient for the company descriptor 415-2 is more predictive of affinity than the coefficient for the industry descriptor 415-1. The coefficient for the functional role descriptor 415-3 is more predictive of affinity than the coefficient for the company descriptor 415-2. The coefficient for the job title descriptor 410-4 is more predictive than the coefficient for the functional role descriptor 415-3. It is understood that, in various embodiments, as the prediction model is trained on training data, the respective coefficients for the hierarchy levels can increase or decrease with regard to how a given coefficient is predictive of affinity between the first member account and the second member account.

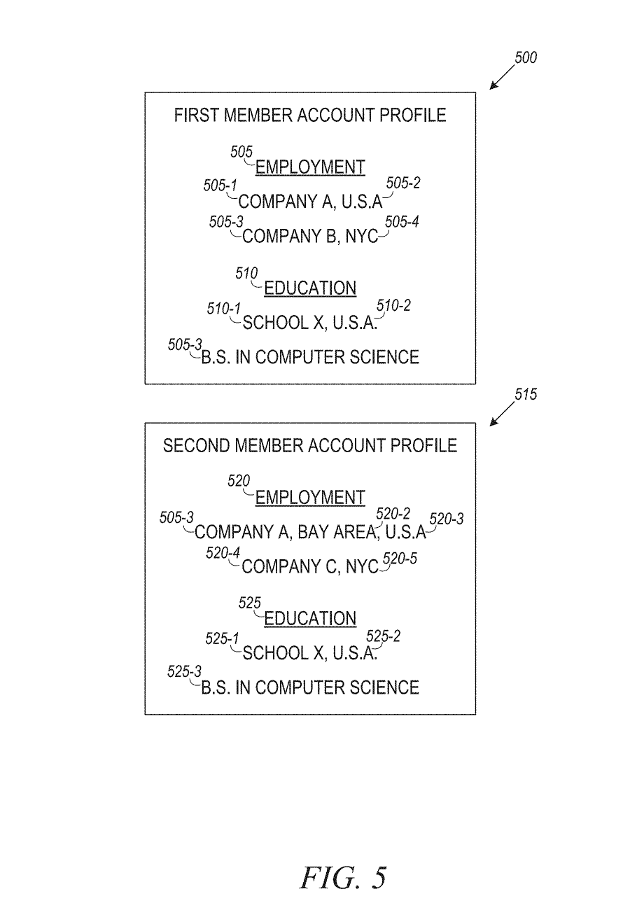

FIG. 5 is a block diagram of profile data attributes of member accounts, in accordance with an example embodiment.

A first member account and a second member account of a social network service have yet to establish a social network connection. The first member account's profile 500 includes an employment section 505 with various industry attributes 505-1, 505-3 and geographical attributes 505-2, 505-4. The first member account's profile 500 includes an education section 510 with various school attributes 510-1, 510-3 and a geographical attribute 510-2. The second member account's profile 515 includes an employment section 520 with various industry attributes 520-1, 520-4 and geographical attributes 520-2, 520-3, 520-5. The second member account's profile 515 includes an education section 525 with various school attributes 525-1, 525-3 and a geographical attributes 525-2.

The Candidate Engine 150 generates keys for input into the prediction model, where each key maps to a specific type of pre-defined feature of the prediction model. In addition, each pre-defined feature is assigned a coefficient (such as a regression coefficient).from a level of a respective attribute hierarchy 405, 410 415. Each key is based on a shared attribute between the first member account's profile 500 and the second member account's profile 515. In addition, some keys will be a combination of a shared school or industry attribute paired with a shared geographic attribute.

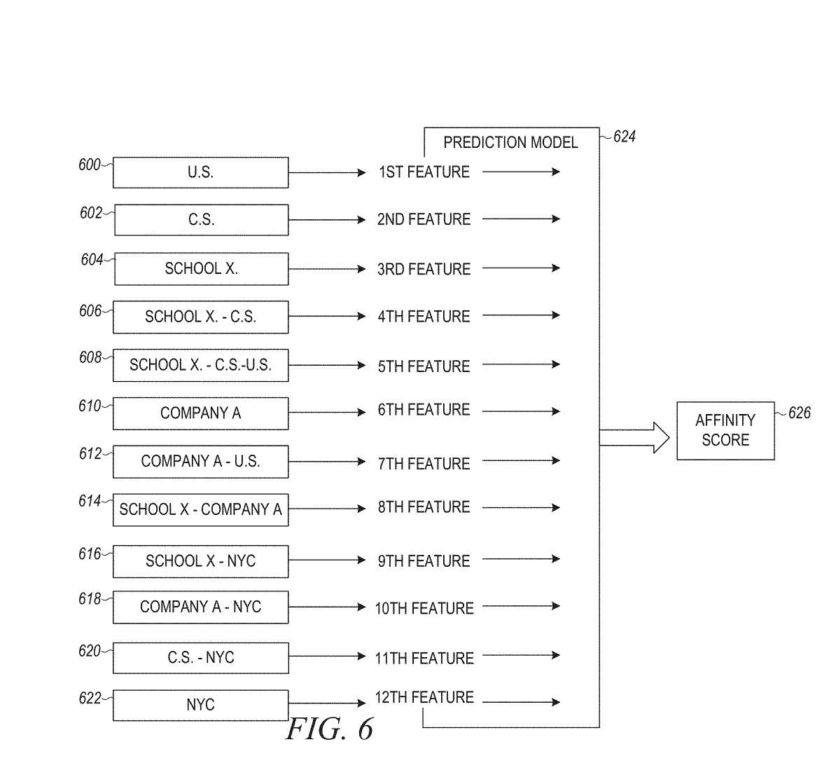

FIG. 6 is a block diagram showing a plurality of keys as input intro a prediction model, in accordance with an example embodiment.

The Candidate Engine 150 generates a key(s) 600, 602, 604, 606, 608, 610, 612, 614, 616, 618, 620. 622 by combining a shared hierarchical data attribute and a shared hierarchical geographic attribute. In other embodiments, a key is based on one or more a shared hierarchical data attributes. Keys are utilized as input into a prediction model 624, which—for example—can be a logistic regression model. The prediction model 624 includes a pre-defined type of feature for each type of input key 600, 602, 604, 606, 608, 610, 612, 614, 616, 618, 620, 622. Each pre-defined type of feature has an associated learned coefficient that represents a degree of importance of the corresponding generated key in determining the affinity between the first member account and the second member.

A first key 600 includes a shared first level geographic attribute (country: “U.S.A.”) present in profile data from the first member account's profile 500 and the second member account's profile 515. A second key 602 includes a shared third level school attribute (field of study: “computer science”). A third key 604 includes a shared first level school attribute (school: “School X”). A fourth key 606 includes a shared first level school attribute (school: “School X”) and a shared third level school attribute (field of study: “computer science”). A fifth key 608 includes a shared first level school attribute (school: “School X”), a shared third level school attribute (field of study: “computer science”) and a shared first level geographic attribute (country: “U.S.A.”).

A sixth key 610 includes a shared second level industry attribute (company: “Company A”). A seventh key 612 includes a shared second level industry attribute (company: “Company A”) and a shared first level geographic attribute (country: “U.S.A.”). An eighth key 614 includes a shared first level school attribute (school: “School X”) and a shared second level industry attribute (company: “Company A”). A ninth key 616 includes a shared first level school attribute (school: “School X”) and a shared third level geographic attribute (city: “N.Y.C.”). A tenth key 618 includes a shared second level industry attribute (company: “Company A”) and a shared third level geographic attribute (city: “N.Y.C.”). An eleventh key 620 includes a shared third level school attribute (field of study: “computer science”) and a shared third level geographic attribute (city: “N.Y.C.”). A twelfth key 622 includes a shared third level geographic attribute (city: “N.Y.C.”). In some embodiments, where an input key includes multiple shared hierarchical data attributes, the particular pre-defined feature that maps to the input key is associated with a learned coefficient that is, at least in part, based on the one or more of the coefficients assigned to the hierarchical level of the respective shared hierarchical data attributes in that input key.

The Candidate Engine 150 assembles feature vector data based on the features and coefficients that correspond to the input keys 600 . . . 622. The prediction model 624 performs a prediction modeling process based on the assembled feature vector data to predict a likelihood of affinity between the first and second member accounts. The prediction model 624 may use any one of various known prediction modeling techniques to perform the prediction modelling process. For example, according to various exemplary embodiments, the prediction module may perform the prediction modeling process based on a statistics-based machine learning model such as a logistic regression model.

Logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event (such as whether two people know each other) given a set of independent/predictor variables. A highly simplified example machine learning model using logistic regression may be 1n[p/(1−p)]=a+BX+e, or [p/(1−p)]=exp(a+BX+e), where 1n is the natural logarithm, logₑₓₚ, where exp=2.71828 . . . , p is the probability that the event Y occurs, p(Y=1), p/(1−p) is the “odds ratio”, 1n[p/(1−p)] is the log odds ratio, or “logit”, a is the coefficient on the constant term, B is the regression coefficient(s) on the independent/predictor variable(s), X is the independent/predictor variable(s), and e is the error term.

The independent/predictor variables of the logistic regression model are the attributes (such as input keys 600 . . . 622) represented by one or more assembled feature vectors. The regression coefficients may be estimated using maximum likelihood or learned through a supervised learning technique from data collected in logs or calculated from log data, as described in more detail below. Accordingly, once the appropriate regression coefficients (e.g., B) are determined, the features included in the assembled feature vector may be plugged in to the logistic regression model in order to predict affinity—as represented by the affinity score 626. In other words, provided one or more assembled feature vectors including various features associated with profile data attributes from a particular pairing of member accounts, the assembled feature vector may be applied to a logistic regression model to determine the affinity between the member accounts.

The prediction model 624 may use various other prediction modeling techniques understood by those skilled in the art to predict whether a particular member will click on a particular content item in a particular context. For example, other prediction modeling techniques may include other machine learning models such as a Naive Bayes model, a support vector machines (SVM) model, a decision trees model, and a neural network model, all of which are understood by those skilled in the art.

Regression coefficients of the logistic regression model may be learned through a supervised learning technique from data collected in logs or calculated from log data. Accordingly, in one embodiment, the Candidate Engine 150 may operate in an off-line training mode by assembling log data based on profile data of a plurality of member accounts into assembled feature vectors. Over time, the log data may include millions or even billions of member account pairings that provide profile data for various types of input keys that correspond with a particular type of pre-defined feature. The assembled feature vectors based on the these input keys may then be processed in accordance with the prediction model 624, in order to refine one or more regression coefficients for the logistic regression model. For example, statistical learning based on the Alternating Direction Method of Multipliers technique may be utilized for this task.

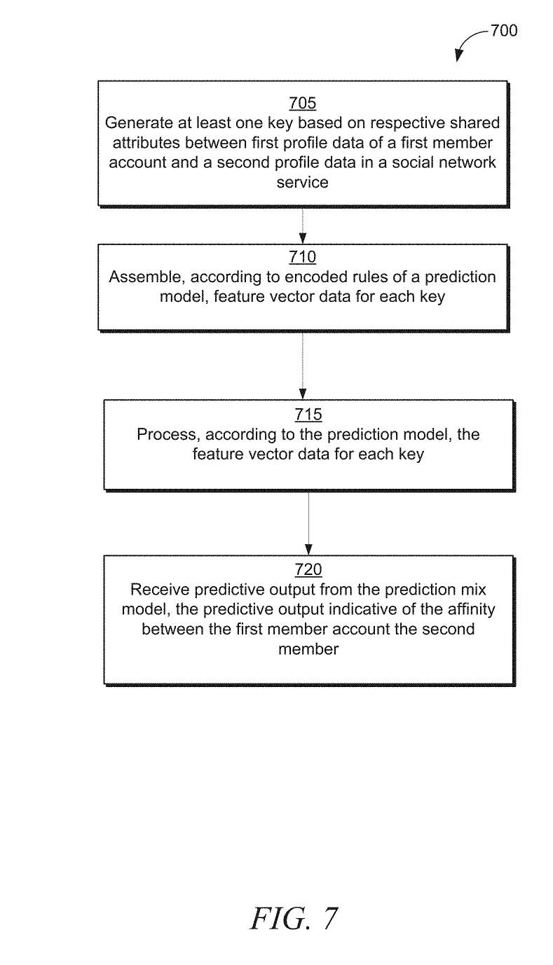

FIG. 7 is a flowchart 700 illustrating an example method for calculating an affinity score according to a prediction model, according to an example embodiment.

At operation 705, the Candidate Engine 150 generating at least one key based on respective shared attributes between first profile data of a first member account and a second profile data in a social network service. The Candidate Engine 150 generates a key that includes at least one shared hierarchical data attribute and at least one shared hierarchical geographic attribute. For example, Candidate Engine 150 identifies a shared geographical descriptor, in a pre-defined geographic attribute hierarchy, present in both the first profile data of the first member account and the second profile data of the second member account. The Candidate Engine 150 inserts the shared geographical descriptor in the key.

According to another example, the Candidate Engine 150 identifies a shared school descriptor, in a pre-defined school attribute hierarchy, present in both the first profile data and the second profile data. The Candidate Engine 150 inserts the shared geographical descriptor in the key. According to another example, the Candidate Engine 150 identifies a shared industry descriptor, in a pre-defined industry attribute hierarchy, present in both the first profile data and the second profile data. The Candidate Engine 150 inserts the shared industry descriptor in the key

At operation 710, the Candidate Engine 150 assembles, according to encoded rules of a prediction model, feature vector data for each key. The encoded rules comprises at least one pre-defined feature predictive of an affinity between the first member account the second member account. In addition, the encoded rules of the prediction model represent one or more respective pre-defined features based on each type of generated key and a respective learned coefficient for each type of generated key. The learned coefficient represents a degree of importance of the generated key in determining the affinity between the first member account and the second member.

At operation 715, the Candidate Engine 150 processes, according to the prediction model, the feature vector data for each key. For example, the prediction model executes one or more logistic regression calculations with respect to one or more feature vectors. The one or more feature vectors are assembled based on the one or more keys input into the prediction model.

At operation 720, the Candidate Engine 150 receives predictive output from the prediction mix model. The prediction model of the Candidate Engine 150 calculates the predictive output, which is indicative of the affinity between the first member account the second member.

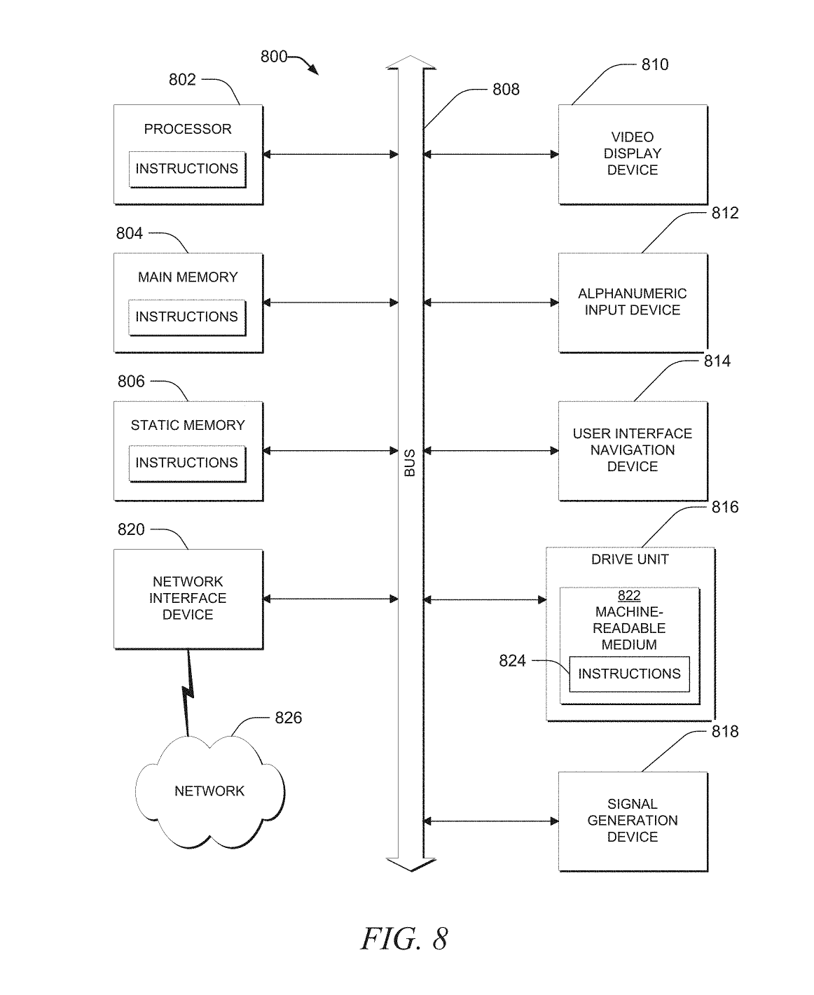

FIG. 8 is a block diagram of a machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a central processing unit (CPU), a graphics processing unit (GPU) or both), a main memory 804, and a static memory 806, which communicate with each other via a bus 808. Computer system 800 may further include a video display device 810 (e.g., a liquid crystal display (LCD) or a cathode ray tube (CRT)). Computer system 800 also includes an alphanumeric input device 812 (e.g., a keyboard), a user interface (UI) navigation device 814 (e.g., a mouse or touch sensitive display), a disk drive unit 816, a signal generation device 818 (e.g., a speaker) and a network interface device 820.

Disk drive unit 816 includes a machine-readable medium 822 on which is stored one or more sets of instructions and data structures (e.g., software) 824 embodying or utilized by any one or more of the methodologies or functions described herein. Instructions 824 may also reside, completely or at least partially, within main memory 804, within static memory 806, and/or within processor 802 during execution thereof by computer system 800, main memory 804 and processor 802 also constituting machine-readable media.

While machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 824 may further be transmitted or received over a communications network 826 using a transmission medium. Instructions 824 may be transmitted using network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
a processor;
a memory device holding an instruction set executable on the processor to cause the computer system to perform operations comprising:
generating at least one key based on respective shared attributes between first profile data of a first member account and second profile data of a second member account in a social network service;
assembling, according to encoded rules of a prediction model, feature vector data for each key , wherein the encoded rules comprise at least one pre-defined feature predictive of an affinity between the first member account and the second member account;
processing, according to the prediction model, the feature vector data for each key; and
receiving predictive output from the prediction model, the predictive output indicative of the affinity between the first member account the second member account.

2. The computer system of claim 1, wherein generating at least one key based on respective shared attributes between first profile data of a first member account and a second profile data in a social network service comprises:
generating a key comprising a shared hierarchical data attribute and a shared hierarchical geographic attribute.

3. The computer system of claim 2, wherein the encoded rules of the prediction model comprises a respective pre-defined feature based on each type of generated key and a respective learned coefficient for each type of generated key, wherein the learned coefficient represents a degree of importance of the generated key in determining the affinity between the first member account the second member.

4. The computer system of claim 2, wherein generating a key comprising a shared data hierarchy attribute and a shared geographical hierarchy attribute comprises:
identifying a shared geographical descriptor, in a pre-defined geographic hierarchy, present in both the first profile data and the second profile data; and
inserting the shared geographical descriptor in the key.

5. The computer system of claim 4, wherein the pre-defined geographic hierarchy comprises a first level for a country descriptor, a second level for a region descriptor and a third level for a city descriptor.

6. The computer system of claim 4, wherein generating a key comprising a shared data hierarchy attribute and a shared geographical hierarchy attribute comprises:
identifying a shared school descriptor, in a pre-defined school hierarchy, present in both the first profile data and the second profile data; and
inserting the shared geographical descriptor in the key.

7. The computer system of claim 6, wherein the pre-defined school hierarchy comprises a first level for a school name descriptor, a second level for a time of attendance descriptor, a third level for a field of study descriptor and a fourth level for a degree obtained descriptor.

8. The computer system of claim 4, wherein generating a key comprising a shared data hierarchy attribute and a shared geographical hierarchy attribute comprises:
identifying a shared industry descriptor, in a pre-defined industry hierarchy, present in both the first profile data and the second profile data; and
inserting the shared industry descriptor in the key.

9. The computer system of claim 8, wherein the pre-defined industry hierarchy comprises a first level for industry descriptor, a second level for a company name descriptor, a third level for a job functional role descriptor and a fourth level for a job title descriptor.

10. A non-transitory computer-readable medium storing executable instructions thereon, which, when executed by a processor, cause the processor to perform operations including:
generating at least one key based on respective shared attributes between first profile data of a first member account and second profile data of a second member account in a social network service;
assembling, according to encoded rules of a prediction model, feature vector data for each key , wherein the encoded rules comprise at least one pre-defined feature predictive of an affinity between the first member account and the second member account;
processing, according to the prediction model, the feature vector data for each key; and
receiving predictive output from the prediction model, the predictive output indicative of the affinity between the first member account the second member account.

11. The non-transitory computer-readable medium of claim 10, wherein generating at least one key based on respective shared attributes between first profile data of a first member account and a second profile data in a social network service comprises:
generating a key comprising a shared hierarchical data attribute and a shared hierarchical geographic attribute.

12. The non-transitory computer-readable medium of claim 11, wherein the encoded rules of the prediction model comprises a respective pre-defined feature based on each type of generated key and a respective learned coefficient for each type of generated key, wherein the learned coefficient represents a degree of importance of the generated key in determining the affinity between the first member account the second member.

13. The non-transitory computer-readable medium of claim 11, wherein generating a key comprising a shared data hierarchy attribute and a shared geographical hierarchy attribute comprises:
identifying a shared geographical descriptor, in a pre-defined geographic hierarchy, present in both the first profile data and the second profile data; and
inserting the shared geographical descriptor in the key.

14. The non-transitory computer-readable medium of claim 13, wherein the pre-defined geographic hierarchy comprises a first level for a country descriptor, a second level for a region descriptor and a third level for a city descriptor.

15. The non-transitory computer-readable medium of claim 13, wherein generating a key comprising a shared data hierarchy attribute and a shared geographical hierarchy attribute comprises:
identifying a shared school descriptor, in a pre-defined school hierarchy, present in both the first profile data and the second profile data; and
inserting the shared geographical descriptor in the key.

16. The non-transitory computer-readable medium of claim 15, wherein the pre-defined school hierarchy comprises a first level for a school name descriptor, a second level for a time of attendance descriptor, a third level for a field of study descriptor and a fourth level for a degree obtained descriptor.

17. The non-transitory computer-readable medium of claim 13, wherein generating a key comprising a shared data hierarchy attribute and a shared geographical hierarchy attribute comprises:
identifying a shared industry descriptor, in a pre-defined industry hierarchy, present in both the first profile data and the second profile data; and
inserting the shared industry descriptor in the key.

18. The non-transitory computer-readable medium of claim 17, wherein the pre-defined industry hierarchy comprises a first level for industry descriptor, a second level for a company name descriptor, a third level for a job functional role descriptor and a fourth level for a. job title descriptor.

19. A computer-implemented method, comprising:
generating, via at least one hardware processor, at least one key based on respective shared attributes between first profile data of a first member account and second profile data of a second member account in a social network service;
assembling, according to encoded rules of a prediction model, feature vector data for each key , wherein the encoded rules comprise at least one pre-defined feature predictive of an affinity between the first member account and the second member account;
processing, according to the prediction model, the feature vector data for each key; and
receiving predictive output from the prediction model, the predictive output indicative of the affinity between the first member account the second member account.

20. The computer-implemented method of claim 19, wherein generating at least one key based on respective shared attributes between first profile data of a first member account and a second profile data in a social network service comprises:
generating a key comprising a shared hierarchical data attribute and a shared. hierarchical geographic attribute.
